(19) United States
(12) Patent Application Publication
(10) Pub. No.: US 2015/0130967 A1
(43) Pub. Date: May 14, 2015

(54) ADAPTIVE DYNAMIC RANGE IMAGING

(71) Applicant: NVIDIA Corporation, Santa Clara, CA (US)

(72) Inventor: Sean Pieper, Mountain View, CA (US)

(73) Assignee: NVIDIA Corporation, Santa Clara, CA (US)

(21) Appl. No.: 14/079,205

(22) Filed: Nov. 13, 2013

(51) Int. Cl. H04N 5/235; H04N 5/265

(52) U.S. Cl. CPC H04N 5/2355; H04N 5/265; H04N 5/2353
USPC 348/239

(57) ABSTRACT

In an apparatus according to one embodiment of the present invention, a video system is disclosed. The video system comprises a pre-processing module, an auto-exposure module, and an image sensor. The image sensor is operable to simultaneously capture a first image at a long exposure and a second image at a short exposure capture. The auto-exposure module is operable to determine an average brightness of a scene for video/image capturing, wherein the determined brightness achieves a desired image quality. The auto-exposure module is further operable to select a dynamic range necessary to preserve desired details in a captured scene. The auto-exposure module is further operable to instruct the image sensor to capture the first image and the second image with a selected exposure ratio to achieve the desired dynamic range. The pre-processing module is operable to combine the first image and the second image into a final image with the desired dynamic range.

### TECHNICAL FIELD

The present disclosure relates generally to the field of image processing and more specifically to the field of high-dynamic range image processing.

### BACKGROUND

Digital photographs and digital video may be captured today using a variety of image sensors (e.g., complementary metal-oxide semiconductor (CMOS) image sensors and charge coupled device (CCD) image sensors. Such image and video capture functionality may be found in mobile devices. However, the design of such compact camera/video systems is complicated by a limited contrast range, also referred to as dynamic range. Furthermore, a lower limit of a dynamic range for an image sensor is governed by read noise and quantization. Even in the absence of read-noise, a charge on a pixel is sampled to a discrete digital value; e.g., a 10-bit value. The charge for a pixel may be digitized using for instance a 10-bit ADC (analog-to-digital converter) to generate a value between 0 and 1023. This means that the brightest area of a scene that may be captured by such an image sensor is roughly 1000 times brighter than the darkest area of the scene that can be simultaneously captured.

Because an image sensor is only capable of measuring a limited dynamic range of light, any information captured by the image sensor is dependent upon an exposure time. Exposure settings may be adjusted to capture details in dark or bright areas of a scene. For example, a short exposure time may prevent bright areas of a scene from saturating corresponding pixel sites; however, detailed information in darker areas of the scene may be lost because the signal received from these areas is too weak to register at all. Conversely, a longer exposure time may allow detailed information in the darker areas to be visible, but at the expense of saturating or overexposing the brighter areas in the scene.

High dynamic range imaging methods have been introduced to aid in expanding the conventional contrast range limitations. High dynamic range imaging enables a scene with great contrast between light and dark to be captured by expanding the range of contrast in the captured image or video. There are a number of technologies that can enable this, such as special sensors with increased dynamic range or by taking multiple image captures using different exposures and integrating back to a single photo. By capturing multiple images at different exposures, the dynamic range may be increased (e.g., an exposure ratio between a long exposure and a short exposure of 8:1, with a 10 bit sensor, will have 13 bits of captured dynamic range).

However, such increases in dynamic range come with various tradeoffs, typically to resolution, signal-to-noise ratio (SNR), sharpness, motion artifacts, color and/or speed, etc. The most common current approach is to take multiple captures with the exposures at a fixed ratio and extend a sensor's dynamic range by a constant amount in exchange for slower capture and strong motion artifacts. These difficulties with capturing multiple images for reconstruction into a single image are exacerbated by the fact that the sensors need to be continuously capturing images for video.

### SUMMARY OF THE INVENTION

Embodiments of the present invention provide solutions to the challenges inherent in high-dynamic range imaging that extends a sensor's dynamic range in exchange for a slower capture and strong motion artifacts. In a method according to one embodiment of the present invention, a method for adaptive dynamic range imaging is disclosed, in which, a scene's dynamic range is calculated. An adaptive dynamic range is selected that is no more than the scene's dynamic range. Scene data is captured with the selected adaptive dynamic range.

In a method according to one embodiment of the present invention, a method for adaptive dynamic range imaging is disclosed. An average brightness of a scene for video/image capture is determined. The determined brightness will achieve a desired image quality. A dynamic range necessary to preserve desired details in a captured scene are determined. An exposure ratio between a short exposure and a long exposure is selected to achieve the desired dynamic range. A short exposure image and a long exposure image are simultaneously captured. The short exposure image and the long exposure image are combined to provide a final image with the desired dynamic range.

In an apparatus according to one embodiment of the present invention, a graphics pipeline is disclosed. The graphics pipeline comprises a pre-processing module and an image sensor. The image sensor is operable to simultaneously capture a long exposure capture and a short exposure capture. The pre-processing module is operable to determine an average brightness of a scene for video/image capturing, wherein the determined brightness achieves a desired image quality. The pre-processing module is further operable to select a dynamic range necessary to preserve desired details in a captured scene. The pre-processing module is further yet operable to instruct the image sensor to capture a long exposure capture and a short exposure capture with a selected exposure ratio to achieve the desired dynamic range. The pre-processing module is further yet operable to combine the short exposure image and the long exposure image into a final image that comprises the desired dynamic range.

### BRIEF DESCRIPTION OF THE DRAWINGS

Embodiments of the present invention will be better understood from the following detailed description, taken in conjunction with the accompanying drawing figures in which like reference characters designate like elements and in which:

FIG. 1 illustrates an exemplary block diagram of a layout of rows of pixels for an exemplary interleaved sensor in accordance with an embodiment of the present invention;

FIG. 2 illustrates an exemplary block diagram of an exemplary image signal processor in accordance with an embodiment of the present invention;

FIG. 3 illustrates a flow diagram, illustrating exemplary steps to a method for adaptive dynamic range image processing in accordance with an embodiment of the present invention;

FIGS. 4A, 4B, and 4C illustrate exemplary graphs of captured data from a sensor illustrating degrees of clipping in accordance with an embodiment of the present invention; and

FIG. 5 illustrates a flow diagram, illustrating exemplary steps to a method for adaptive dynamic range image processing in accordance with an embodiment of the present invention.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Adaptive Dynamic Range Imaging:

Embodiments of this present invention provide solutions to the increasing challenges inherent in achieving a high-dynamic range without unacceptable motion artifacts and/or vertical resolution. Various embodiments of the present disclosure provide an adaptive dynamic range (ADR) imaging system. As discussed in detail below, a ratio between short exposure times and long exposure times may be adjusted so that a captured dynamic range matches, but does not exceed, a scene's measured dynamic range, and thus allowing image quality to be maximized.

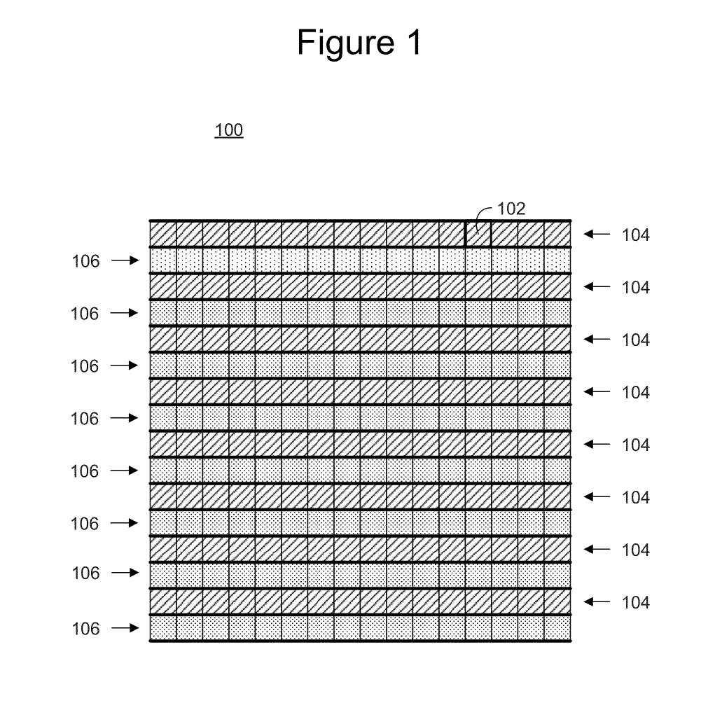

In one embodiment, an exemplary interleaved image sensor provides interleaved capture of a single image at two programmable exposures. As illustrated in FIG. 1, an interleaved sensor provides interleaved pixel data 100 comprising a plurality of alternating rows 104, 106 exposed at different exposure times or lengths. For example, as illustrated in FIG. 1, pixels 102 of long exposure rows 104 are exposed at a longer exposure length as compared to pixels 102 of short exposure rows 106. As also illustrated in FIG. 1, the long exposure rows 104 and the short exposure rows 106 are alternating or interleaved with respect to one another.

Image processing may then be performed to combine the two interleaved images into a single image with greater dynamic range than a standard image, but with reduced vertical resolution and/or colorful horizontal, motion-induced artifacts (also referred to as motion artifacts). The greater the captured dynamic range, the worse the image quality tradeoffs will be. At one extreme, if the two exposures are equal (with an exposure ratio of 1:1), the full vertical resolution may be trivially obtained by doing nothing. That is, not combining the two images, and simply treating the interleaved images as a single image. At the other extreme, the two images are too different, that for the vast majority of the scene, either one or the other must be used due to either clipping or noise floor. When just a single one of the two images are used, the vertical resolution will be halved. Similarly, a magnitude of the motion artifacts (which may be traded against resolution) is a function of both degree of motion and exposure ratio. However, allowing for the interplay of spatial resolution tradeoffs versus motion artifacts, interleaved images may allow the continuous capture of high-dynamic ranged video images for encoding and storage and/or monitoring.

In an exemplary adaptive dynamic range (ADR) imaging system, a ratio between short exposure times and long exposure times (herein referred to as an exposure ratio) may be adjusted so that a captured dynamic range matches, but does not exceed a measured scene dynamic range, thus allowing image quality to be maximized. This exposure ratio may also drive tradeoffs in the processing of the interleaved data, particularly between motion artifacts and vertical resolution.

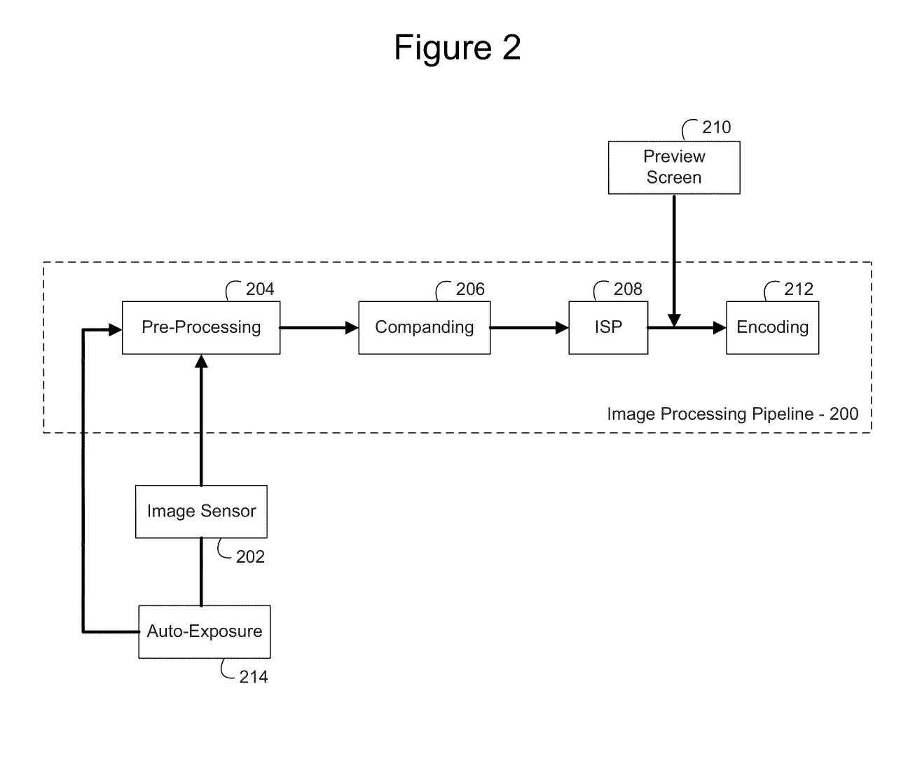

FIG. 2 illustrates an exemplary image processing pipeline 200 coupled to an interleaved image sensor 202 in accordance with one embodiment. As illustrated in FIG. 2, the image processing pipeline 200 comprises a pre-processing engine 204, a companding engine 206, an image signal processor (ISP) 208, and an encoding engine 212. As discussed herein, the interleaved image sensor 202 generates image sensor data based on two different exposure times, a short exposure time and a long exposure time that are applied to interleaved rows of pixels, such as the long exposure rows 104 and the short exposure rows 106 illustrated in FIG. 1. The pre-processing engine 204 receives image sensor data from the image sensor 202 and generates high-dynamic range data that is available for preview via a preview screen 210 and eventually encoded for storage. As illustrated in FIG. 2, an auto-exposure module 214 is also coupled to the interleaved image sensor 202 and the pre-processing engine 204. As discussed herein, the auto-exposure module 214 is also operable to select exposure times for the interleaved images captured by the interleaved image sensor 202, as well as determining an exposure ratio between the short exposure time and the long exposure time.

In one embodiment, a companding engine 206 may be used to reduce an amount of bits used per intensity value in the HDR data in a non-linear manner, such that a conventional ISP 108 may be used to process the high-dynamic range data. In one embodiment, the HDR data is passed through a compression function comprising power functions driven by the selected exposure ratio (e.g., the power function will approach 1 as the exposure ratio approaches 1:1). The power function may be set such that 18% gray in the captured image remains fixed. Therefore, more bits of the original HDR image may be used to distinguish between lower levels of the signal than bits that are used to distinguish between higher levels of the signal. If the companding engine 206 were not implemented in the image processing pipeline 200, then an ISP 208 configured to process, for example 10-bit data, could not operate on the HDR data with an expanded dynamic range (e.g., an exposure ratio of 8:1 will extend the conventional 10-bit data to a 13-bit dynamic range). The companding engine 206 may also scale the HDR data down to the original LDR dynamic range for further processing by a conventional ISP 208. In one embodiment, the image processing pipeline 100 does not have a companding engine 206 and the ISP is configured to process the HDR data at the higher bit width.

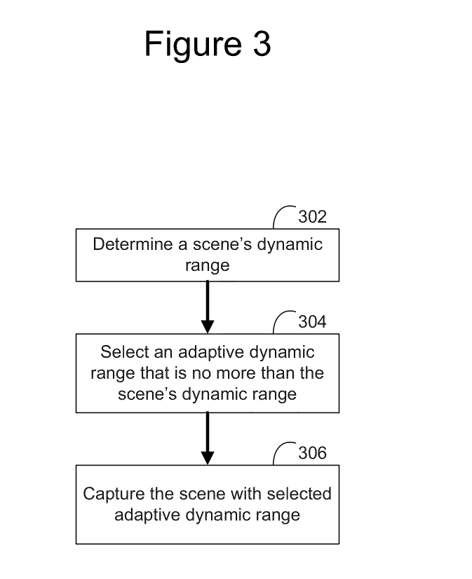

FIG. 3 illustrates an exemplary process for selecting an exposure ratio for adjusting a high-dynamic range. In one embodiment, the steps to the process for selecting an exposure ratio are executed by the auto-exposure module 214, illustrated in FIG. 2. In step 302 of FIG. 3, a scene's dynamic range is determined. In one exemplary embodiment, a light meter may be used to determine a dynamic range of the scene. In step 304 of FIG. 3, an adaptive dynamic range that is no more than the scene's dynamic range is selected. In one embodiment, the selected adaptive dynamic range is less than the scene's dynamic range. In one embodiment, a ratio between a short exposure time and a long exposure time is selected to achieve the desired adaptive dynamic range. In step 306 of FIG. 3, the scene is captured with the selected adaptive dynamic range. In one embodiment, a pair of interleaved exposures are combined into a single image by the pre-processing engine 204 of FIG. 1. In one exemplary embodiment, the processed single image is companded (compressed and expanded) by the companding engine 206 of FIG. 1. Lastly, in one embodiment, the companded, processed single image is processed by a conventional ISP engine 208 of FIG. 1.

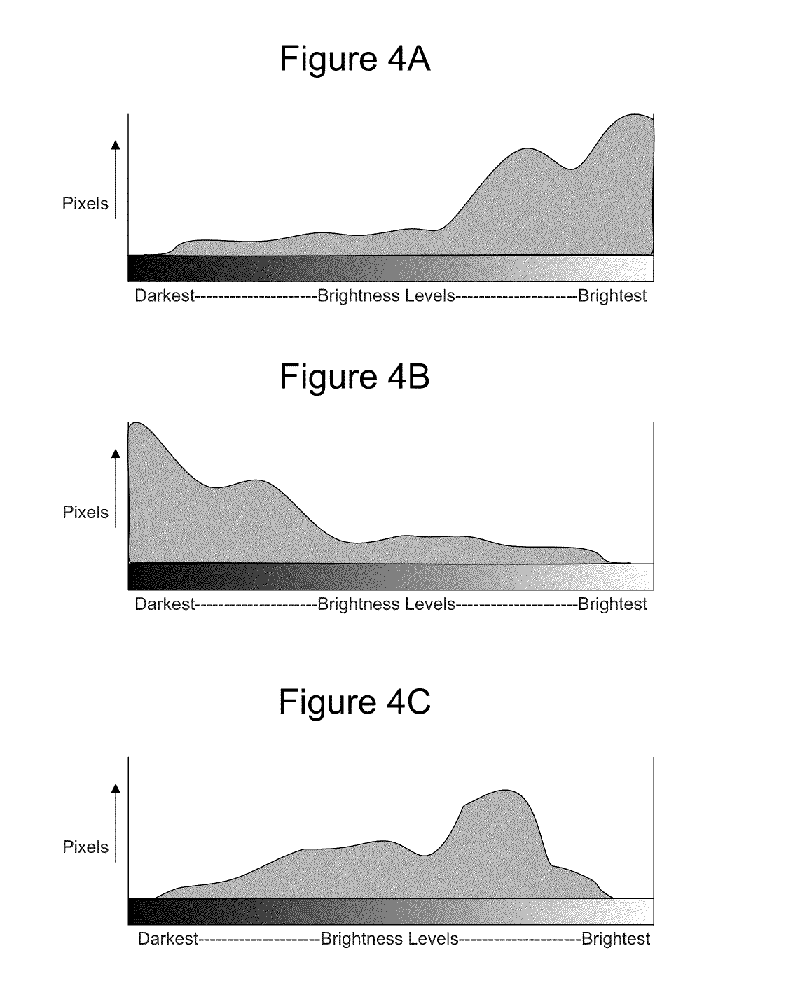

In one embodiment, an auto-exposure process of an exemplary continuous capture system (e.g., a video capture system) may be reformulated as two problems. Generally, auto-exposure processes, executed by an auto-exposure module 214, may be used to balance captured brightness levels with information loss due to clipping. As illustrated in FIGS. 4A and 4B, clipping results when capturing or processing an image where an intensity in a certain area of a scene falls outside a minimum and maximum intensity which can be represented-such that the clipped area of the image may appear as a uniform area of the minimum or maximum brightness, losing any image detail.

FIG. 4A illustrates clipping of maximum intensity, while FIG. 4B illustrates clipping of minimum intensity. As illustrated in FIG. 4A, the graph is clipped to the right and consequently, the scene captured is overexposed and the brightest details are lost due to the clipping. As illustrated in FIG. 4B, the graph is clipped to the left and consequently, the scene captured is underexposed and the darkest details are lost due to the clipping. However, as illustrated in FIG. 4C, clipping may be avoided by extending the dynamic range of the captured image(s). Therefore, two problems are presented: determining an average scene brightness for a sensor capture to achieve good image quality, and determining a dynamic range necessary to preserve information in the captured image. In other words, managing the interaction between auto-exposure algorithms and the reconstruction of the final image.

Any number of existing techniques for auto-exposure may be used for the first problem (determining an average scene brightness for sensor capture to achieve a good image quality) which will then determine a mid-point of the captured dynamic range, or the duration of the long exposure (of the pair of interleaved exposures). For example, one exemplary technique is to monitor an average of a particular quantile of the scene and adjust an exposure so that it meets a particular selected level. For example, a middle 3^{rd} of the captured image data may be mapped to 20% of a long exposure's range (mean/median control). In another embodiment, a lower 1% of the captured image data may be mapped to a bottom 1% of the long exposure's range. In one embodiment, in order to set an exposure ratio conservatively, highlights of the scene are separately metered. As discussed herein, the light meter should be looking at a top portion of the scene, but should be avoiding spurs of highly lit regions of the scene, such as flares. For example, the highlight behavior of the scene may be determined by gradually removing other portions of the scene (such as extremely dark portions and extremely bright portions that might only be random spurs or flares) so that the actual highlights of the scene may be identified.

The second problem controls the ratio of the short exposure to the long exposure. In one embodiment, a level of the brightest pixels in a scene is monitored. In another embodiment, a level of the darkest pixels in the scene is monitored. The selection of pixels to monitor (brightest or darkest) may be controlled depending on whether the first stage of the process (as discussed above) determines the long exposure or a mid-point of the captured range. For example, if the long exposure is set such that an average brightest captured in the scene is appropriate, but there is a lot of data being clipped, the sensor's dynamic range may be increased at the expense of resolution, and thus the exposure ratio may be increased. Similarly, if there is no data being clipped or even near the top of the range, too much vertical resolution is being sacrificed needlessly, and so the dynamic range may be reduced by making the short exposure closer to the long exposure. However, there will also be situations when the level of spatial resolution must be sacrificed to avoid unpleasant motion artifacts.

In general, both properties (selection of an average brightness captured and selection of a desired dynamic range) may need to be altered simultaneously. An exemplary process determining exposure ratio control may take account of any changes to the long exposure before performing its analysis. As with any other property in a continuous capture system, these changes may be damped, as discussed herein. Weighting and color information may also be used in generating a guiding histogram as is done in conventional auto-exposure processes.

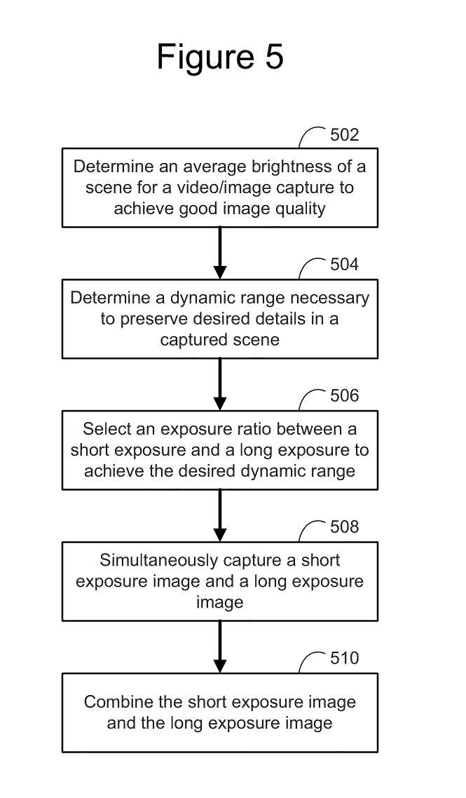

In FIG. 5, an exemplary flow diagram for dynamically adjusting a dynamic range is illustrated. As discussed herein, an interleaved sensor 202, as illustrated in FIG. 2, may capture an image comprising a pair of interleaved images captured at two different exposure times. As discussed herein, the difference between the exposure times is known as an exposure ratio and defines the selected dynamic range.

In step 502 of FIG. 5, an average brightness of a scene is determined that is sufficient to achieve a good image quality. In one embodiment, the highlights of the scene are metered. In step 504 of FIG. 5, a dynamic range necessary to preserve desired details in a captured image is selected. In step 506 of FIG. 5, an exposure ratio between a short exposure and a long exposure is selected to achieve the desired dynamic range determined in step 504 of FIG. 5.

In step 508 of FIG. 5, a short exposure image and a long exposure image are simultaneously captured. As discussed herein, in one embodiment, the short exposure image and the long exposure image are part of an interleaved image produced by an interleaved sensor 202, as illustrated in FIG. 2. Finally, in step 510 of FIG. 5, the short exposure image and the long exposure image are combined to create a reconstituted image with an extended dynamic range. In one embodiment, the combination of the short exposure image and the long exposure image is controlled by the current exposure ratio and the current average brightness determined for the long exposure.

### Interleaved Image Reconstruction:

Once an exposure ratio between a long exposure time and a short exposure time has been determined, a process that combines the simultaneously captured, interleaved images may be adjusted in response to the exposure ratio. As discussed herein, spatial resolution and motion artifacts may be smoothly traded off as a function of exposure ratio by controlling the maximum difference in blend as a function of position and signal level.

To achieve a preferred spatial resolution in the final image, if there is reasonably good signal quality on both the long exposure rows 104 and the short exposure rows 106, then for a given row, that entire row of pixels may be used without combining with adjacent rows (in other words, no reconstruction is need, the interleaved images are treated as a single image). Such a reconstruction would provide the best spatial resolution. For example, for exposure ratios near one (e.g., 1.1:1, 1.2:1, and 1.125:1), short exposure rows 106 and long exposure rows 104 may be used more or less identically. In other words, as discussed herein, for an exposure ratio near 1:1, no reconstruction is necessary; the two interleaved images may be treated as a single image provided no pixels are clipped. However, as the exposure ratio begins to open up, the amount of motion captured in the long exposure rows 104 will begin to manifest as motion artifacts.

A magnitude or length of motion artifacts may also be driven by exposure difference (which is a function of exposure durations and exposure ratio) as in practice, scene motion isn't affected by how a scene is captured. For example, at an exposure ratio of 1.1, if the exposure duration of the short exposure rows 106 is very long (e.g., 100 ms), the long exposure rows 104 may capture approximately 10 ms more of motion (e.g., with an exposure duration of 110 ms) which may generate substantial artifacts. In contrast, at an exposure ratio of 4, but where the exposure duration of the short exposure rows 106 is only an exemplary tenth of a millisecond, the difference in captured motion may be only about 0.075 ms. Assuming an object that moves across a sensor's field of view in 100 ms, in the first case, there would be a visible artifact extending across 10% of the screen, while in the second case, there would be a visible artifact extending across 0.075% of the screen (which may not even be perceptible). By making the blending of long exposures and short exposures consistent, based on exposure ratio (while taking into account the exposure difference) and independent of row, the fingers may be eliminated, but resolution may be lost (e.g., for a long exposure time and a high exposure ratio). The closer the blending across the rows, the less the motion artifact will show through; and also the lower the exposure ratio or exposure difference, the less severe the motion artifact may be. Therefore, in one embodiment, a recombination of the short exposure rows 106 and the long exposure rows 104 may be controlled by exposure difference (a function of the exposure duration and the exposure ratio) so that blending of the exposure rows 104, 106 will be minimal when the exposure time is short, even when the exposure ratio is large.

In one embodiment, a consistent amount of short exposure (from the short exposure image) may be included, regardless of the row that is currently being considered. Such a process may help to reduce motion artifacts (e.g., finger artifacts), but may degrade spatial resolution. In one embodiment, the reconstruction of the long exposure rows 104 and the short exposure rows 106 into a single image may be conservatively adjusted as a function of the current exposure ratio. Ideally, the reconstruction may be smoothly and gradually adjusted as the exposure ratio changes. For example, the reconstruction may become more aggressive to allow a consistent amount of motion artifacts to appear, while maximizing the spatial resolution. In one embodiment, when the exposure resolution is 1:1, no blending is needed. Each row (whether long exposure or short exposure) is just treated as a row of the final image. However, as the exposure ratio increases, taking into account the exposure difference, as discussed herein, the reconstruction (e.g., blending of the rows) may smoothly and gradually reach a point where only one of the two images is retained (the spatial resolution of the final image is reduced to half).

In one embodiment, for high exposure ratios and long exposure durations, the short exposure rows 106 may be used when the long exposure rows 104 are clipped. Similarly, the long exposure rows 104 may be used when the short exposure rows 106 are clipped. However, as discussed herein, the long exposure rows 104 may be blurry, due to motion artifacts, especially if, as discussed above, there is a significant exposure difference.

There is also another type of artifact which may be driven by exposure ratio and local intensity which is caused by changes in SNR between exposure rows. This type of artifact may not be affected by exposure time, and can cause an apparent texture if it is not accounted for. Thus, in one embodiment, the blending of the long exposure rows 104 and the short exposure rows 106 will consider both types of artifacts.

In one embodiment, the reconstruction is conservatively managed so that spatial resolution is only sacrificed when a gain from increasing the dynamic range is worth the reduction in spatial resolution. On the other hand, while the reconstruction is conservatively blending the rows to conserve as much of the spatial resolution as possible, an auto-exposure process may also be managed such that the dynamic range is as conservative as possible (so that the auto-exposure captures just enough dynamic range to capture all of the desired image content).

In one embodiment, a continuously adaptable dynamic range, as provided by an auto-exposure process, will be paired with a reconstruction of interleaved images, such that the reconstruction process (as executed by the pre-processing module 203, of FIG. 2) is kept informed as to what the current dynamic range is and may adapt the reconstruction process according to conservative criteria such that a minimal amount of spatial resolution may be traded off to remove or at least reduce undesirable motion artifacts. In other words, the dynamic range will be adjusted as needed (e.g., if the auto-exposure indicates that a desired dynamic range is within a conventional dynamic range, then there is no reason to do anything at all). There may be situations when there is no reason to enter an HDR mode at all.

In one embodiment, all exposure ratio changes and the corresponding dynamic range adjustments may be smooth and gradual. This prevents jarring resolution changes (e.g., suddenly changing from smooth lines to jaggy lines) that would disrupt the viewing experience. In one embodiment, a sudden jump from a high quality spatial resolution to a high dynamic range (while sacrificing spatial resolution) is prevented. Therefore, rather than “popping” in and out of a high dynamic range (HDR) mode in response to changing scene exposure levels, embodiments of this invention provide for conservative and gradual adjustments to the exposure ratio to prevent a sudden and shifting dynamic range.

In one embodiment, damping processes similar to that used for auto-exposure may be incorporated in adaptive dynamic range (ADR) imaging as well. Therefore, should the exposure ratio need to shift from a current exposure ratio of 1:1 to a desired exposure ratio of an exemplary 8:1, the ADR system will damp the changes down so that the continuous exposure control will slowly adjust the exposure ratio of the two images so that the exposure ratio gradually and smoothly leaves 1:1 to approach the desired exposure ratio of 8:1. In one embodiment, the damping is a log of the ratio of the change (so that doubling or halving an exposure are treated equally). Therefore, the ratio damping will allow a hysteresis loop, so that the HDR system will not suddenly jump into or out of HDR mode. As discussed herein, the dynamic range as controlled by the exposure ratio, may smoothly and gradually change depending on an amount of change in the exposure ratio.

In one embodiment, an input range for an exemplary image signal processor may be limited to 10 bits, so there will be some companding necessary as discussed herein (as provided by a companding engine 106 of FIG. 1). This companding may cause changes in hue and saturation. However, the dynamic range may be used to control a companding curve such that this loss of color fidelity varies smoothly as a function of an exposure ratio. One way of doing this is to solve for a piecewise curve that always maps some fixed percentage of the long exposure to the same level of the output (in one embodiment, 20 percent may be used, as this is considered “mid-gray”). The end of this linear region may be called a “knee.” The rest of the companding curve is a power function whose exponent may be solved for, based on the equation:

$$\frac{1 + \frac{log ( knee )}{{log}^{ratio}}}{\frac{log ( knee )}{{log}^{ratio}}} .$$

As the ratio approaches one, this equation also approaches one and thus the entire curve becomes linear. A similar process may be used to construct a pure power curve that matches the long exposure at a single point.

### Dynamic Range Adjustments for Non-Continuous Capture:

While the embodiments discussed above have generally involved continuous capture, for still photography with flash, there may be times when an exposure control system 214 of FIG. 2 will not be in continuous auto-exposure control. For example, consider a flash photography scenario where a low-power flash may be used for estimating exposure and determining a desired dynamic range before a high-power flash is fired. Before the low-power flash is fired, the dynamic range may be set very large to get better statistics. The low-power flash taken with a higher dynamic range is analyzed, and based upon a knowledge of how much light the high-power flash contributes, and how much ambient light has been measured, the dynamic range may be adjusted again to a desired range.

Another embodiment trades off flash image quality in exchange for avoiding the need for a pre-flash (using a low-power flash) by having a dynamic range large enough that the flash is unlikely to overexpose foreground objects. This avoids the time spent collecting data from multiple flashes (a low-power flash and a high-power flash).

In one embodiment, adaptive dynamic range imaging could be activated for a particular anticipated light level for flash photography with damping turned off. A dynamic range may be selected and quickly acquired that will allow foreground objects that are lit by the flash to not be overexposed, while background objects will not be underexposed due to the low ambient light. In other words, if a flash is used, there may be an assumption that a particular HDR setting will be used, based upon the selected exposure range (for flash photography).

In one embodiment, unless an HDR setting is being selected and acquired for flash photography, an exposure ratio (which, as discussed above, controls the dynamic range) adjustment is damped. In one embodiment, an image/video capture system in a DSLR, a cellphone, a smart phone, or other portable computing device provides a continuously captured video output to a preview screen 212, as illustrated in FIG. 2.

### Multiple Sensor Embodiments:

Exemplary embodiments may also be used with a system that uses mirrors to perform two equal resolution captures at different exposures, as might be appropriate in a digital single lens reflex (DSLR) camera with multiple sensors. In this case, the motion artifacts would not be relevant, but the control over dynamic range would improve SNR and color fidelity. In one embodiment, an exemplary DSLR comprises two separate sensors, each capturing an image at a different exposure time as defined by a selected exposure ratio. The pair of captured images (also referred herein as a long exposure image and a short exposure image) may be combined so that an extended dynamic range may be achieved while avoiding a reduction in spatial resolution.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A method for adjusting a dynamic range for an image capture system, the method comprising:
determining an average brightness of a scene as captured by the image capture system;
selecting a dynamic range necessary to preserve desired details in a captured image of the scene based on the average brightness of the scene;
selecting an exposure ratio between a short exposure and a long exposure to achieve the desired dynamic range;
simultaneously capturing a first image at the short exposure and a second image at the long exposure; and
for an exposure ratio not near unity (1:1), combining the first image and the second image to provide a final image with the desired dynamic range.

2. The method of claim 1, wherein rows of pixels of the first image and rows of pixels of the second image are interleaved as alternating rows of a third image.

3. The method of claim 1, wherein the combining the first image and the second image is controlled by at least one of the exposure ratio and exposure durations.

4. The method of claim 2, wherein the first image and the second image are captured by an interleaved sensor.

5. The method of claim 2, wherein for an exposure ratio near unity (1:1), the first image and the second image are not combined and the interleaved third image is the final image.

6. The method of claim 2, wherein for an exposure ratio greater than 8:1, the final image comprises uncombined pixel rows of one or more of the first image and the second image, and wherein the final image comprises half of the rows of the first image and the second image.

7. The method of claim 1, wherein the selecting a dynamic range comprises selecting a dynamic range that is equal to or less than the dynamic range of the scene.

8. The method of claim 1, wherein selecting the exposure ratio comprises adjusting a current exposure ratio to a selected exposure ratio, and wherein the adjusting the current exposure ratio to the selected exposure ratio is damped according to a log of a ratio of a change in exposure ratio.

9. A method for adjusting a dynamic range of an image capture device, the method comprising:
calculating a dynamic range of a scene;
selecting a dynamic range that is no more than the dynamic range of the scene; and
capturing desired scene data, wherein the captured scene data is within the selected dynamic range.

10. The method of claim 9, wherein the selecting a dynamic range of the scene comprises adjusting a current dynamic range to the selected dynamic range, and wherein the adjusting the current dynamic range to the selected dynamic range is damped according to a log of a ratio of a change in dynamic range.

11. The method of claim 9 further comprising continuously adapting the dynamic range.

12. A graphics processor comprising:
a pre-processing module;
an auto-exposure module operable to select a selected dynamic range necessary to preserve desired details in a captured scene, based upon an average brightness of the captured scene; and
an image sensor operable to simultaneously capture a first image of the scene at a long exposure and a second image of the scene at a short exposure;
wherein the auto-exposure module is further operable to instruct the image sensor to capture the first image and the second image with a selected exposure ratio to achieve the selected dynamic range, and wherein the pre-processing module is operable to combine the first image and the second image into a final image with the selected dynamic range.

13. The graphics processor of claim 12, wherein the first image and the second image each comprise rows of pixels, and wherein the rows of pixels of the first image and the rows of pixels of the second image are interleaved as alternating rows of a third image.

14. The graphics processor of claim 12, wherein the pre-processing module is further operable to control the combining of the first image and the second image into the final image according to at least one of:
the exposure ratio between the long exposure and the short exposure; and
exposure durations.

15. The graphics processor of claim 12, wherein the image sensor comprises an interleaved sensor operable to simultaneously capture the first image and the second image as an interleaved image with odd rows pertaining to the first image and even rows pertaining to the second image.

16. The graphics processor of claim 14, wherein for an exposure ratio near unity (1:1) the pre-processing module is operable to not combine the first image and the second image and the interleaved third image is the final image.

17. The graphics processor of claim 14, wherein for an exposure ratio greater than 8:1, the pre-processing module is operable to combine the first image and the second image into the final image, wherein the final image comprises uncombined pixel rows of one or more of the first image and the second image, and wherein the final image comprises half of the rows of the first image and the second image.

18. The graphics processor of claim 12, wherein the selected dynamic range is equal to or less than the dynamic range of the scene.

19. The graphics processor of claim 12, wherein the auto-exposure module is further operable to select exposures times for the first image and the second image.

20. The graphics processor of claim 19, wherein the auto-exposure module is further operable to adjust the current exposure ratio to the selected exposure ratio with a damping according to a log of a ratio of a change in exposure ratio.
